(19) United States
(12) Patent Application Publication
(10) Pub. No.: US 2012/0282812 A1
(43) Pub. Date: Nov. 8, 2012

(54) ELECTICAL CONNECTOR WITH TWO GROUPS OF CONTACTS

(75) Inventors: MIN-HAN LIN, New Taipei (TW); KUO-CHUN HSU, New Taipei (TW); TO-YING CHEN, New Taipei (TW)

(73) Assignee: HON HAI PRECISION INDUSTRY CO., LTD., New Taipei (TW)

(21) Appl. No.: 13/464,068

(22) Filed: May 4, 2012

(30) Foreign Application Priority Data
May 4, 2011 (TW) 100115634

(51) Int. Cl. H01R 31/06

(52) U.S. Cl. 439/638

(57) ABSTRACT

The electrical connector includes a first main body, a number of first contacts, a second main body assembled on the first main body and with a head portion and a extending board, and a number of second contacts received in the second main body. The first contact includes a extending arm fixed on the base portion, a first mating portion extending from one end of the extending arm to be received in the first receiving passage. The second contact comprises a fastening arm fixed on the head portion and a second mating arm extending from the fastening arm to be received in the second contact slots. The first contact has a connecting arm extending from the other end of the extending portion opposite to the first mating arm. The connecting arm and the fastening arm are connected to each other.

### BACKGROUND OF THE INVENTION

1. Field of the Invention

The present invention relates generally to an electrical connector, and more particularly to an electrical connector with two groups of contacts.

2. Description of the Prior Art

U.S. Pat. No. 6,364,713 issued to Kuo on Apr. 2, 2002 discloses an electrical connector adapter assembly. The electrical connector adapter assembly comprises a first dielectric housing, three sets of first terminals retained in the first dielectric housing, a printed circuit board (PCB), a second dielectric housing, and two sets of second terminals retained in the second dielectric housing. The first and second terminals are electrically connected with each other by the PCB. As the PCB is present in the electrical connector adapter assembly, the adapter assembly becomes large in its outline and will occupy a large space. On the other hand, as the first and second terminals are electrically connected with each other through the PCB, the signal may be attenuated during transmission.

Hence, in this art, an improved electrical connector is desired.

### BRIEF SUMMARY OF THE INVENTION

A primary object, of the present invention is to provide an electrical connector with two groups of contacts to have good signal transmission performance.

In order to implement the above object, the electrical connector comprises a first main body, a plurality of first contacts, a second main body assembled on the first main body and a plurality of second contacts received in the second main body. The first main body comprises a base portion and a mating portion extending from the base portion in a horizontal direction, the mating portion has a receiving space and a first receiving passages formed in the mating portion to communicate with the receiving space. The first contact comprises a extending arm fixed on the base portion, a first mating portion extending from one end of the extending arm to be received in the first receiving passage. The second main body comprises a head portion and a extending board extending from the head portion in a mating direction. The extending board has a plurality of second contact slots located on the upper surface thereof and extending along the mating direction. The second contact comprises a fastening arm fixed on the head portion and a second mating arm extending from the fastening arm to be received in the second contact slots. The first contact has a connecting arm extending from the other end of the extending portion opposite to the first mating arm. The connecting arm and the fastening arm are connected to each other.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating an electrical connector according to a preferred embodiment of the present invention;

FIG. 2 is a perspective view similar to FIG. 1, but viewed from another angle;

FIG. 3 is an exploded, perspective view of FIG. 1;

FIG. 4 is an exploded, perspective view similar to FIG. 3, but viewed from another angle;

FIG. 5 is an assembly perspective view illustrating contacts of the electrical connector in according to the first embodiment of the present invention; and

FIG. 6 is an assembly perspective view illustrating contacts of the electrical connector in according to the second embodiment of the present invention.

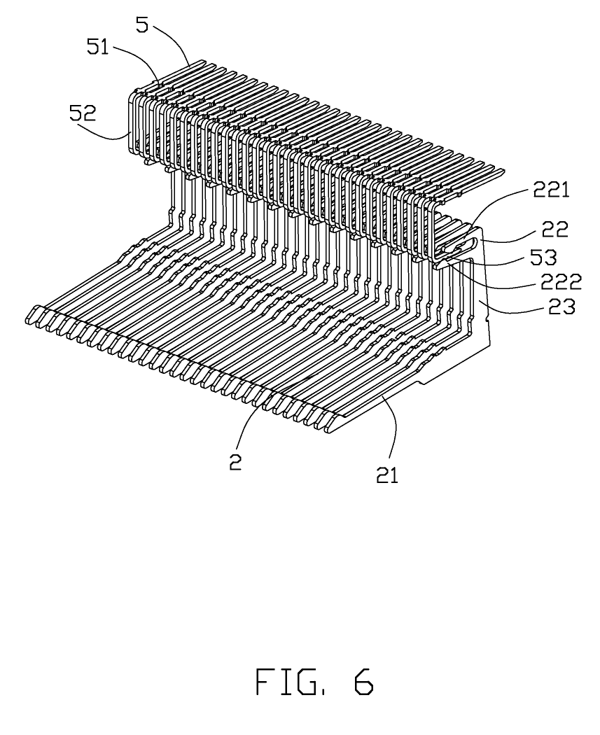

### DETAILED DESCRIPTION OF THE INVENTION

Reference will now be made in detail to a preferred embodiment of the present invention.

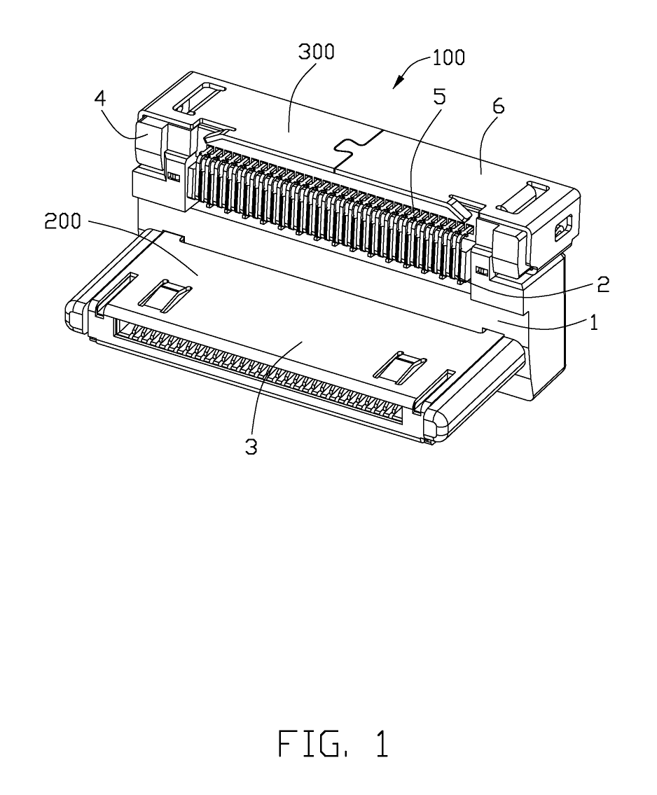

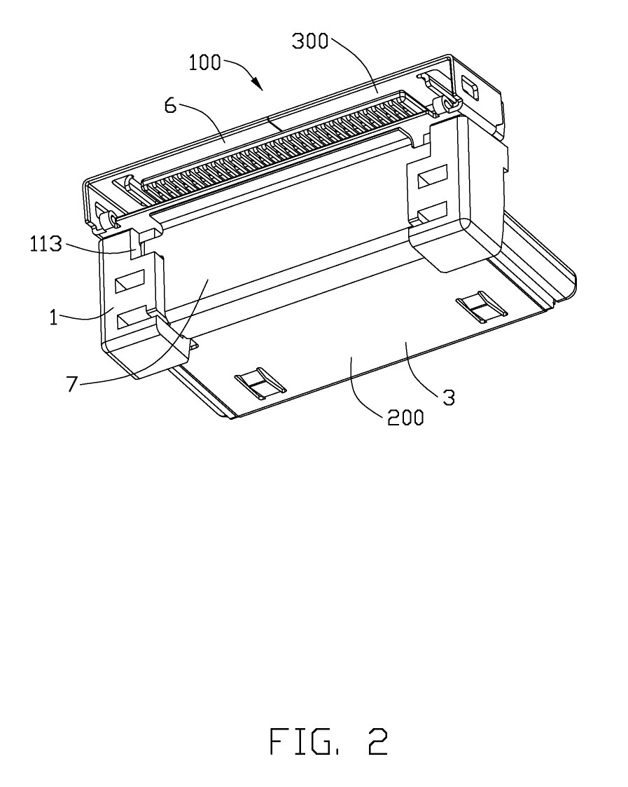

Referring to FIGS. 1 to 2, an electrical connector 100, used to transfer signals, comprises a first connector 200 and a second connector 300 located above the first connector 200. The first connector 200 is used to mate to a jack connector (not shown) and the second connector 300 is used to correspond to a plug connector (not shown). The first connector 200 comprises a first main body 1, a plurality of first contacts 2 received in the first main body 1, and a first cover 3 covering the first main body 1. The second connector 300 comprises a second main body 4, a plurality of second contacts 5 received in the second main body 4, and a second cover 6 covering the second main body 4.

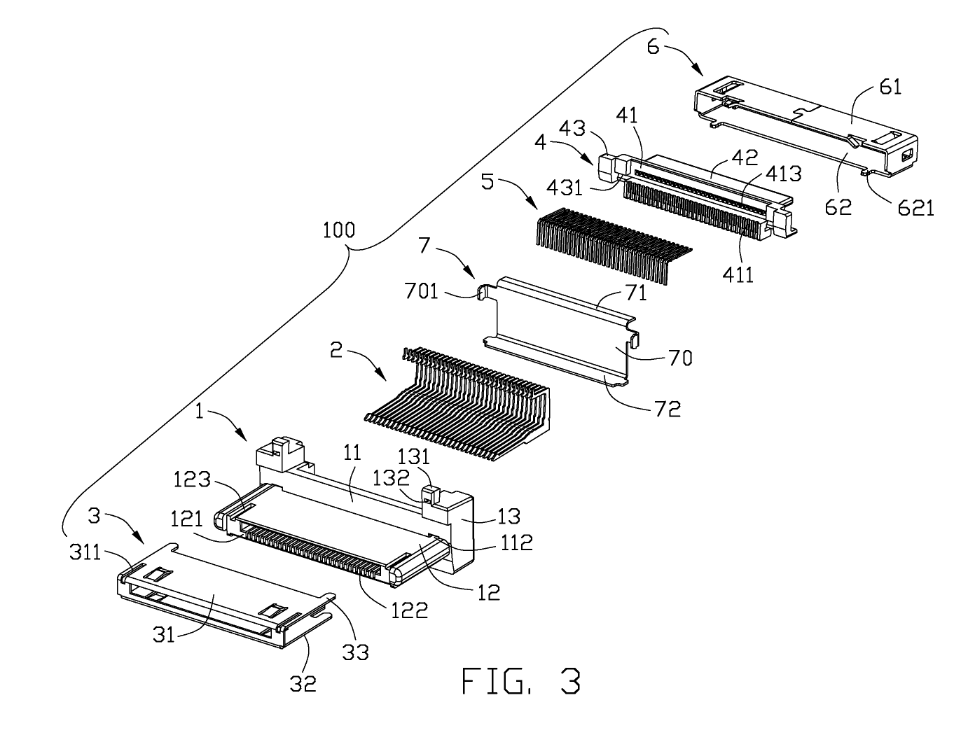

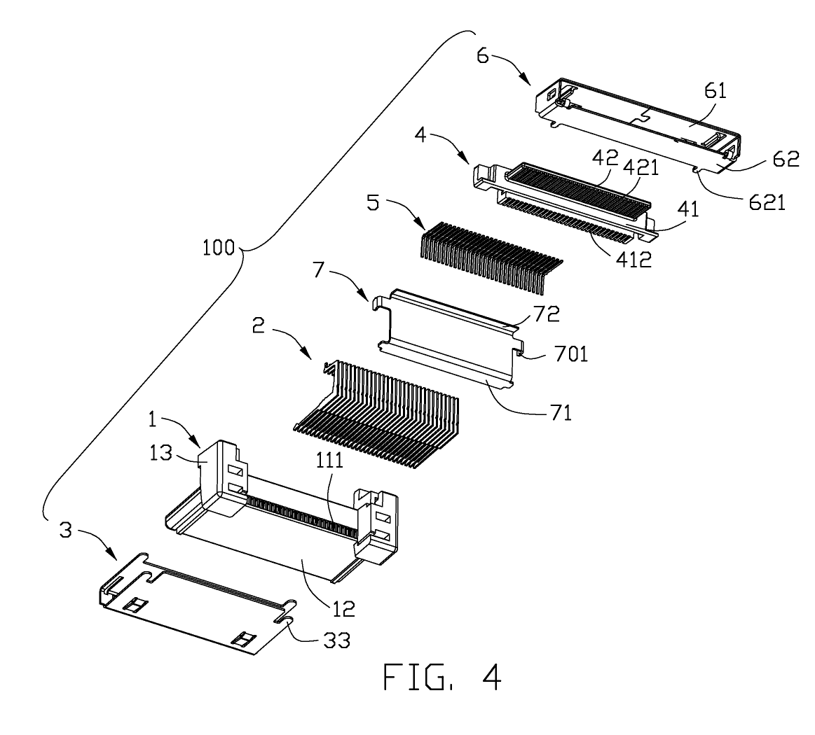

Referring to FIG. 3 and FIG. 4, the first main body 1 includes a base portion 11 and a mating portion 12 extending frontward from the front surface of the base portion 11 along a horizontal direction. Two pair of recesses 112 are defined on the front surface of the base portion 11. The two pair of recesses 112 respectively inward extend from the front surface of the base portion 11 and are respectively located on the two sides of two joint lines of the base portion 11 and the mating portion 12. The mating portion 12 comprises a receiving space 121 to form a frame portion 124 around the receiving space 121, and a plurality of first receiving passages 122 formed on a bottom wall 1241 of the frame portion 124 toward the receiving space 121 and communicating with the receiving space 121. The first receiving passages 122 pass through the mating portion 12 to form a first open portion 111 on a rear surface of the mating portion 12. A pair of receiving slots 123 is defined on the upper surface of the mating portion 12 and rearward extends from two sides the front surface of the mating portion 12. The base portion 11 comprises a pair of fastening portions 13 located on two sides thereof, and each fastening portion 13 has a protrusion 131 extending upward from the upper surface thereof and a hole 132 passing through the front surface and the rear surface of the protrusion 131. The second main body 4 is assembled on the first main body 1 along a up-to-down direction. The second main body 4 comprises a head portion 41 and a extending board 42 rearward extending from the head portion 41 along a horizontal direction. The extending board 42 extends along a direction opposite to the direction the mating portion 12 extends along and the extending board 42 and the mating portion 12 are located on two different levels. The head portion 41 has a group of first troughs 411 located on the front surface thereof and a group of second troughs 412 located on the under surface thereof and corresponding to the first troughs 411. Every pair of corresponding troughs 411, 412 are communicated with each other. The extending board 42 defines a plurality of second contacts slots 421 extending along a mating direction and along the upper surface of the extending board 42. The second contacts slots 421 pass through the head portion 41 in the mating direction to form a second open 413. The head portion 41 has a pair of fastening elements 43 corresponding to the fastening portions 13, and each fastening element 43 has a cutout 431 corresponding to the protrusions 131 of the fastening portions 13 to receive the corresponding protrusion 131.

The first cover 3 is made by pressing and bending a metal patch, and comprises an upper surface 31 and a lower surface 32 opposite to the upper surface 31. The upper surface 31 and the lower surface 32 respectively has a pair of branch portions 33 respectively corresponding to the two pair of recesses 112. Each branch portion 33 extends along the mating direction to be received in the corresponding recess 112. A pair of spring slices 311 is defined on the two sides of the upper surface 31 to extend toward the lower surface 32 and correspond to the two receiving slots 123. Each spring slice 311 is attached on the inner surface of the corresponding receiving slot 123. The second cover 6 is also made by pressing and bending a metal patch and comprises an upper surface wall 61 and a lower wall 62 opposite to the upper wall 61. The lower wall 62 has a pair of extending tails 621 frontward extending from the front edge of the lower wall 62 to correspond to the holes 132. When the second main body 4 and the second cover 6 are assembled on the first main body 1, the extending tails 621 are inserted into the holes 132 to fix the electrical connector 100 firmly.

The electrical connector 100 further comprises a shielding portion 7 which is substantially of Z shape. The shielding portion 7 comprises a vertical piece 70, a first side piece 71 rearward extending from the top of the vertical piece 70 along the horizontal mating direction and a second side piece 72 frontward extending from the bottom of the vertical piece 70. The vertical piece 70 has a pair of fastening pins 701 frontward extending from two sides thereof and the base portion 11 of the first main body 1 has a pair of fastening holes 113 located on the pair of fastening portions 13 to correspond to the fastening pins 701. The fastening pins 701 are received in the fastening holes 113 to fasten the shielding portion 7 on the base portion 11 firmly. The first side piece 71 is attached on the lower wall 62 of the second cover 6 and the second side piece 72 is attached on the lower surface 32 of the first cover 3. The shielding portion 7 is fixed on the first main body, the first cover 3 and the second cover 6 through soldering method to enhance the strength of whole electrical connector 100.

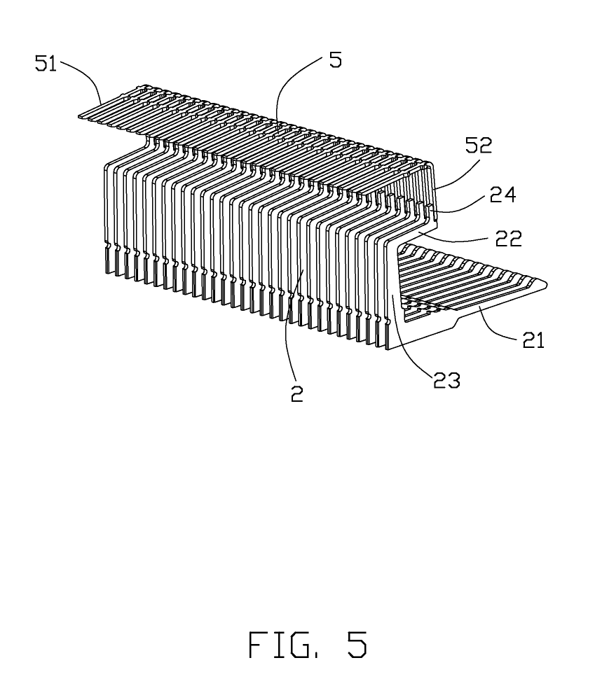

Referring to FIG. 5, the mating method of the first contacts 2 and the second contacts 5 in according to the first embodiment is shown. The first contact 2 comprises a extending arm 23 fixed on the base portion 11, a first mating arm 21 extending from one end of the extending arm 23 along a horizontal direction and a connecting arm 22 extending from the other end of the extending arm 23 along a horizontal direction. The first mating arms 21 are inserted into the receiving space 121 through the first open portion 111 to be received in the first receiving passages 122. The connecting arms 22 are received in the second troughs 412 and extend upward to form a plurality of touching tails 24 to be inserted into the first troughs 411. The second contact 5 comprises a fastening arm 52 fixed on the head portion 41 and a second mating arm 51 extending from the fastening arm 52 along a horizontal direction. The second mating arms 51 are inserted into second contacts slots 421 trough the second open 413. The fastening arms 52 are received in the first troughs 411 and physically connected to the touching tails 24 of the first contacts 2.

Referring to FIG. 5, the mating method of the first contacts 2 and the second contacts 5 according to the second embodiment is shown. In the second embodiment, the connecting arms 22 of the first contacts 2 comprises an upper arm 221 and a lower arm 222 which two respectively extend along directions approximately parallel to each other. The upper arm 221 and its corresponding lower arm 222 respectively has a protrusion (not signed) and the two protrusions face to each other to catch the second contact 5. The fastening arm 52 of the second contacts 5 further has a touching piece 53 extending therefrom along a horizontal direction and the touching piece and the mating arm 51 are located on the same side of the fastening ami 52. The touching pieces 53 extend into the second troughs 412 and are inserted into the slots of the connecting arms 22 to be attached by the corresponding protrusions of the upper and lower arms 221, 222.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a first main body comprising a base portion and a mating portion extending from the base portion in a horizontal direction, the mating portion having a receiving space and a plurality of first receiving passageways;
a plurality of first contacts each comprising an extending arm fixed on the base portion and a first mating arm received in the first receiving passageway;
a second main body assembled on the first main body, the second main body comprising a head portion and an extending board extending from the head portion in a mating direction, the extending board having a plurality of second contact slots extending along the mating direction;
a plurality of second contacts received in the second main body, each second contact comprising a fastening arm fixed on the head portion and a second mating arm received in the second contact slot; wherein
the first contact has a connecting arm extending from the other end of the extending portion opposite to the first mating arm, and the connecting arm and the fastening arm are connected to each other.

2. The electrical connector as claimed in claim 1, wherein said connecting arm of the first contact comprises a touching tail upward extending from the one end of the first contact.

3. The electrical connector as claimed in claim 2, wherein said fastening arm is soldered on the touching tail.

4. The electrical connector as claimed in claim 1, wherein said connecting arm of the first contact comprises an upper arm and a lower arm extending approximately parallel to each other to form a slot therebetween.

5. The electrical connector as claimed in claim 4, wherein said fastening arm has a touching piece and the touching piece and the mating arm are located on the same side of the fastening arm.

6. The electrical connector as claimed in claim 5, wherein said touching piece is inserted into the slot in the connecting arm.

7. The electrical connector as claimed in claim 1, further comprising a first cover covering the first main body and a second cover covering the second main body.

8. The electrical connector as claimed in claim 1, wherein said extending board and the mating portion extend along opposite directions and are located on two different levels.

9. The electrical connector as claimed in claim 1, wherein said head portion has a group of first troughs located on one surface thereof and a group of second troughs located on another surface thereof corresponding to the first troughs.
